(19) United States
(12) Patent Application Publication
(10) Pub. No.: US 2011/0238851 A1
(43) Pub. Date: Sep. 29, 2011

(54) Soap Client Protocol Encapsulation Based on TCP

(75) Inventors: CHUNFEI ZHANG, Nanjing (CN); Haihua Song, Nanjing (CN); Bendong Wei, Nanjing (CN); Fuhai Gao, Nanjing (CN); Libin Sun, Nanjing (CN); Haidong Pang, Nanjing (CN); Zhiqiang Lu, Nanjing (CN)

(73) Assignee: LINKAGE TECHNOLOGY GROUP CO., LTD., Nanjing (CN)

(21) Appl. No.: 13/072,698

(22) Filed: Mar. 26, 2011

(30) Foreign Application Priority Data
Mar. 26, 2010 (CN) 201010133694.8

(51) Int. Cl. G06F 15/16

(52) U.S. Cl. 709/230

(57) ABSTRACT

SOAP client protocol encapsulation Based on TCP , based on the short TCP connection, SOAP client protocol encapsulation method, the client package for SOAP protocol, that is Web Services Description Language WSDL file into xml file, put to the client application's configuration file which, variable part of the SOAP protocol allows all the code from the configuration file object after conversion, and then generated after the body of SOAP protocol: 1) client load WSDL converted xml file; 2) the client application to read out the configuration file, the xml with the application to transfer data into a SOAP message body; 3) in the generated SOAP message body together with SOAP message header, turned into a complete SOAP request; 4) We will be based on TCP short connection to the complete SOAP request sent to the web services server, then receive and process about the content of web services to return, to complete a full SOAP interface calls; All the web Services client: a client using the same source, and adopt a unified approach to a request to the web service server.

### CROSS REFERENCE TO THE RELATED PATENT APPLICATION

The present application claims the priority of the Chinese patent application No. 201010133694.8 filed on Mar. 26, 2010, which application is incorporated herein by reference.

### FIELD OF THE INVENTION

This invention belongs to the technical field of software protocol interfaces. It is based on TCP protocol process SOAP (Simple Object Access Protocol) message interface and is mainly used for SOAP encapsulated client protocol, which is based on TCP short connection method. The present invention does not involve the server side of SOAP business processes. It is different from the one currently preferred in the software industry which handle not only SOAP server side but also client side. In that way, why this invention only encapsulated the client? The sacrifice of the server side features for the sake of being more targeted, because the major part of our business is the development of application system which involves either only the client, even though in very rare cases we develop SOAP client to connect to our own SOAP server. As a result, this invention is proposed regarding to the feature of being more targeted.

### BACKGROUND OF THE INVENTION

Among the current system of telecom operators, SOAP interfaces are widely used. However, more and more types of protocol interface defined that there is need to develop a variety of SOAP interface, and interfaces will be developed for each corresponding WSDL file (WSDL means is Web Service Description Language). It in general means that each have an interface development need and we have to re-develop a system according to WSDL, which is a source code to the re-released version, even if it is going to upgrade the existing interface and release a source. Therefore, developing the telecommunication industry, the software interfaces are usually set up in groups, and are responsible for the development of these departments specialized in interfaces. Since interface is quite different software and development costs are considerably high, The early development of these interfaces, the latter version of the maintenance, upgrade, labor costs are quite consumption.

In this environment, for the difference between shielded protocol interface to formulate a unified interface mode, such as China Telecom iSPP project, telecom operators are required to unify all interfaces under the way in the SOAP protocol interface. Many platforms are now upgraded to SOAP interfaces, nevertheless, this is only the way to solve a unified network protocol without really solving the problem on business development, and besides, upgrade for this interface mode will generate a series of questions: (FIG. 1 WSDL file release diagram, which is the old way)

### 1) Upgrade Interface

The upgrade of this interface, such as the need of XML node in the SOAP protocol to add a parameter information node, will result in the need to re-publish WSDL file by using this WSDL file system (including client and server) to be re-compiled and published. Their applications, maintenance and upgrades are going to bring large amount of labor costs.

### 2) Add a New Interface

In the Add a new SOAP interface to the time, also according to WSDL compile a set of C/C++ code or java code for the appropriate development language called (currently C/C++ in the field of the more popular build tools for the gSOAP, java in the field of the more popular build tools: axis2); use of these tools are the same;

Only when the client needs to develop, popular development tools have the same problem: from the WSDL file is compiled as C/C++ or java source code, recompile the source code and modify the operational parameters of the re-compiled release new applications, that is to upgrade the application code to resolve Problem.

### SUMMARY OF THE INVENTION

Of the present invention to solve the problem is: the completion of the agreement package SOAP client using the character stream mode, and can support a variety of SOAP protocol, Because of the present invention to SOAP message body stored in the configuration file system, a; IT'S feature is that if the wsdl file is changed (interface formats have changed), no need to recompile the wsdl generated C/C++ or java code, the same does not need to re-release applications program can directly solve the problem. Although the problem can be solved with the previously mentioned gSOAP and Axis are the same, but they are not the same implementation process so that we programmers in the development of new interfaces, And upgrade the old interface do not like gSOAP and Axis to re-release source code;

The invention of the technology program: Short TCP connections based on SOAP client protocol encapsulation method, encapsulated SOAP protocol for the client to fill in the variable part of the SOAP protocol, namely WSDL Web Services Description Language file extracted, compiled for the xml to the client placed the application configuration file, SOAP protocol so that all of the variable part of the object from the configuration file, after conversion after the code to generate SOAP protocol body.

As follows:

1) the use of third-party tools to load WSDL file compiled into xml;

2) the client application to read out the configuration file, the xml with the application to transfer the data into SOAP message body;

3) in the generated SOAP message body before adding SOAP message header; into a complete SOAP request;

4) We use the short TCP connection to the SOAP request sent to the web services server, and then do something about returning the contents of web services, which completed a full SOAP interface calls;

All the web Services client uses the same client, using a unified approach to a request to the server.

Server using third-party tools to provide the WSDL Web Services Description Language format description file, compiled into a real xml format, in which third-party tools for the gSOAP, soapUI.

Client via TCP short connection, send SOAP request, when received back after the break web Services server socket connection.

SOAP protocol in the TCP was originally implemented on a short connection, general development tools are introduced compiled concept; the WSDL file directly compiled into C/C++ or java code, let the compiler produce the source code to the client application directly calls; However, the present invention is to WSDL conversion to xml Format, into the client's configuration file; so that the variable part of the SOAP protocol from the configuration file to all of the code converted by the body generates SOAP protocol; make all the web Services clients can use the same set of client-side source code, uniform Approach, called all kinds of SOAP protocol.

The method does not involve business process SOAP server; this is different from the software industry is currently a popular SOAP software that can handle both processing services to the client side; the reason why only the client package, remove the server Package features, because this can be more targeted.

The present invention completed the package SOAP client protocol, the use of the way the characters flow package, and can support a variety of SOAP protocol operation, because the SOAP message body of the invention into the configuration file system, so when the WSDL file occurred When change does not need to re-compile and publish a new application, according to WSLD documents, compiled into the xml document, combined with application data can be converted to a SOAP message body for the SOAP interface calls. The characteristics of the present invention is: If the WSDL file is changed, that is, changes occurred in the interface format, does not need to re-compile the WSDL generated C/C++ or java code, do not need to re-publish the application can directly solve the problem. To upgrade the interface or when adding a new interface, do not need as gSOAP, Axis, like to re-upgrade source.

The present invention used in the development and upgrading of web Services client, the application's source code does not need to be republished. On the SOA architecture which also applies, and this is the current web Services development tools provided by different local features such as the current gSOAP, axis2 WSDL files need to be recompiled so that they can not be done without recompiling the client source code.

The present invention is to solve the WSDL document each change, we must upgrade the applications of these problems. Of the present invention to achieve: a change even if the WSDL file, and only need to modify the xml configuration file format. The invention requires a lot of access to different kinds of web Services server time, he will be a unified access method, and do not need to re-develop applications; just use the third-party tool to translate WSDL xml, and the xml configuration to the client application configuration file can complete web Services request process; Makes a variety of vendors and platforms web Services Agreement easily get unified access, easy integration with a client application of them. In Web Service SOAP interfaces for the platform. After using the present invention: When the interface format changes, no need to repeat the development cost can go directly to the construction of links, Customer site by our own staff to directly configure the application to complete the business needs.

### BRIEF DESCRIPTION OF THE DRAWINGS

Embodiments of the invention will now be described, by way of example only, with reference to the accompanying drawings, of which;

FIG. 1 The old way for SOAP encapsulated client protocol

FIG. 2 Schematic application of the method of the invention

FIG. 3 This is the SOAP message structure decomposition

### DETAILED DESCRIPTION OF THE PREFERRED EMBODIMENT

The kernel of this invention is to encapsulate the SOAP protocols on TCP short connections. The technical scheme of this invention is as follows: firstly we extract xml contents from SOAP protocol to configuration files, then the variable parts of SOAP protocols can be created by the program that base on the configuration files, with the corresponding SOAP head added, we get the complete SOAP request. By using this scheme, all Web Service clients can adopt the same program to process different SOAP protocols.

The scheme of this invention contains 3 steps:

1) Compile wsdl files to xml files of SOAP protocol format using third-party tools (e.g. soapUI, gSOAP);

2) Copy the xml files' contents to the configuration files of this invention;

3) The program of this invention reads the configuration files, combines the configuration info and the data that need to be transformed, then converts these data to formal SOAP data, adds the SOPA message head, creates a short TCP connection with Web Service server and sends messages, disconnects the socket connection on receiving the server's response.

SOAP protocol is implemented based on TCP short connection originally. General developing tools compile the wsdl files to C/C++/JAVA source codes. Then applications can use these source codes directly. The kernel of this invention is to encapsulate the SOAP protocols on TCP short connections and extract xml contents that located in protocols originally to configuration files. Thereby the variable parts of SOAP protocols can be created by the program of this invention that base on the configuration files. Then all Web Service clients can use same program codes and have same process mode for different SOAP protocols.

The development and updating of Web Service clients using this invention in SOA architecture are different with other general Web Service developing tools. When clients changed, this invention's application program need not to redistribute resource code. In contrast, general tools (e.g. Gsoap, axis2) must recompile the wsdl files and clients source codes.

The aim of this invention is to solve the trouble that we must update applications when wsdl files changed, and achieve that we only need to change the xml contents in configuration files when wsdl files changed. When the application needs to visit many different Web Service servers, this invention enable us to have an uniform visiting method and make updating program not necessarily. The only thing we need to do is to use third-party tools to create xml files from wsdl files and configure the xml files into the application configuration files of this invention. Then the complete Web Service request procedure is done. This enables us to visit Web Service of different platforms and different providers easily and congruously by one client application.

In many platforms which have Web Service interface, such as AAA platform of Tianjin Telecom, SIP short message platforms of Jiangsu Telecom, OCS platforms of the whole country, after using this invention, applications save the cost for duplicate development. Engineers of deployment can configure the application directly and satisfy the system's business requirement.

Concrete Implementation Method

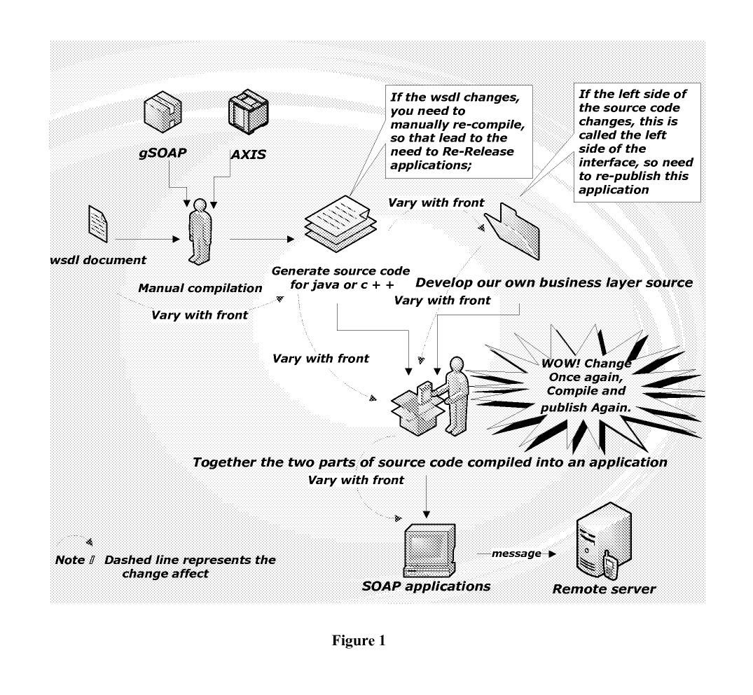

As FIG. 1, at present all Web Service development tools compile wsdl files to C/C++/JAVA codes and distribute to Web Service applications. If wsdl files change, this means the interface format changing, we have to recompile the wsdl files to codes and redistribute the applications.

For example, a project of telecom that has hundreds of outer interface uses the above-mentioned method. If the project upgrades its Web Service server, all interface programs must be recompiled and redistributed. Corresponding workloads burden on re-development not on maintenance without doubt.

In this invention, all Web Service client programs do not need re-development theoretically. Client programs using this invention's method can upgrade interface by changing configuration files without changing programs. We can access Web Service interface of various platforms by using one and the same thread class. In other words, all Web Service clients can come from one and the same codes; the different parts of Web Service protocols are configurable. Hundreds of interface system can have the same software edition with extreme expansibility and less re-development workload.

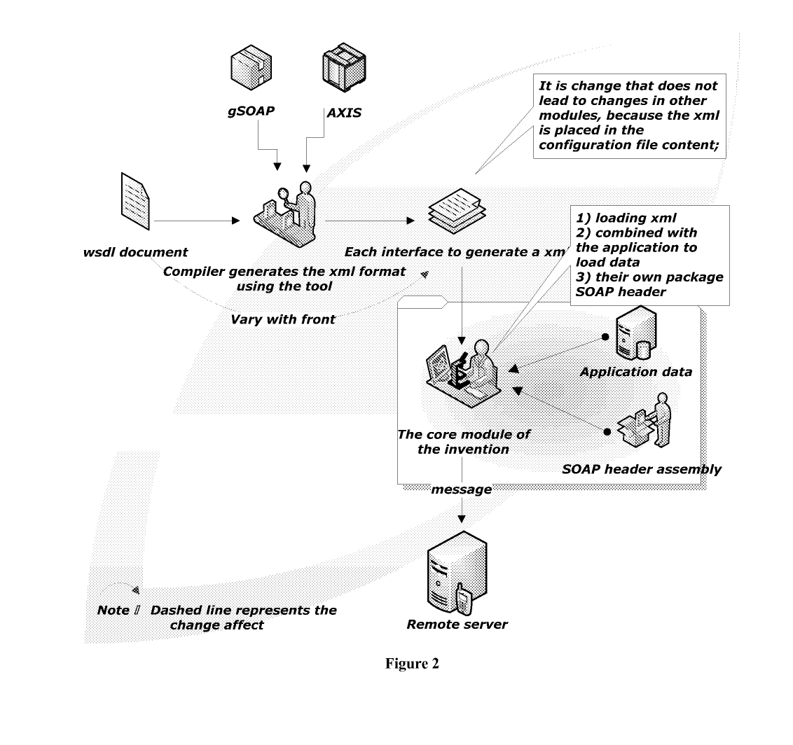

As FIG. 2, this invention needs pre-configure of various interface manually. If new interface occurs, configure it. Then the Web Service client reads these configurations together and invokes the interface. However, in FIG. 1, in most cases, Web Service development will compile wsdl files to source codes, then recompile these codes and distribute interface program. Each times a new Web Service interface added, we have to recompile the source codes and redistribute the client program.

By comparison with traditional method of Web Service clients development, this invention has more convenient maintenance and upgrading, can save huge labor costs.

Compare FIG. 1 with FIG. 2, see the red lines, we can find out the influence of the wsdl changing.

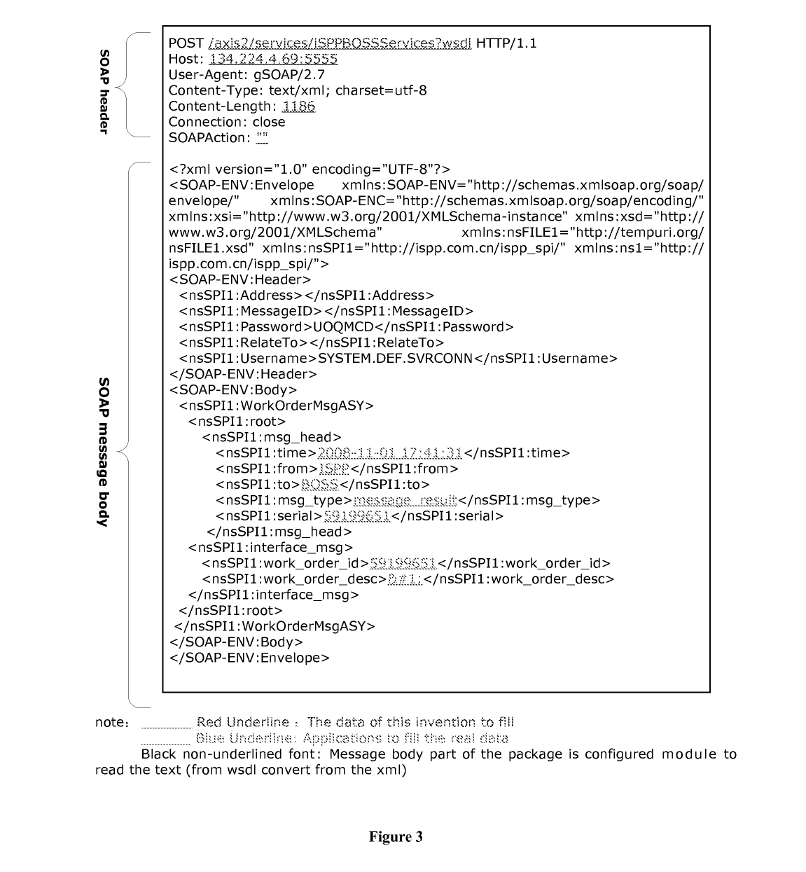

This CWebServiceEpt is important to extend the class of the invention, the development of ideas shown in FIG. 3: (FIG. 3 for the SOAP client message structure decomposition)

The invention itself encapsulated SOAP messages, SOAP message is composed of two parts: 1.SOAP header 2.SOAP message body; the SOAP message body is in the xml configuration file with our application, the composition of real data; so that you can generate complete The SOAP request; through the system to establish ‘TCP short connection’ to send out and process the results can be returned;

What is claimed is:

1. A SOAP client protocol encapsulation method based on the short TCP connection, wherein the client package for SOAP protocol, that is web services description language WSDL file into xml file, put to the client application's configuration file which, variable part of the SOAP protocol allows all the code from the configuration file object after conversion, and then generated after the body of SOAP protocol:
1) client load WSDL converted xml file;
2) the client application to read out the configuration file, the xml with the application to transfer data into a SOAP message body;
3) in the generated SOAP message body together with SOAP message header, turned into a complete SOAP request;
4) we will be based on TCP short connection to the complete SOAP request sent to the web services server, then receive and process about the content of web services to return, to complete a full SOAP interface calls;
all the web Services client: a client using the same source, and adopt a unified approach to a request to the web service server.

2. The method of claim 1 wherein by the use of third party tools provided by the service-side WSDL Web Services Description Language format description xml file is compiled as a real format, here said third-party tools to gSOAP, soapUI.

3. The method of claim 1, wherein by short TCP connection by the client to send SOAP request to, upon receipt of web Services server returns a message, broken open socket connection.

4. The method of claim 2, wherein by short TCP connection by the client to send SOAP request to, upon receipt of web Services server returns a message, broken open socket connection.
